(19) United States
(12) Patent Application Publication
(10) Pub. No.: US 2013/0337850 A1
(43) Pub. Date: Dec. 19, 2013

(54) POWER CONSUMPTION IN A CELLULAR DEVICE WITH ENHANCED IDLE MODE SIGNAL REDUCTION USING DUAL STANDBY

(71) Applicant: Rickard Ljung, Helsingborg (SE)

(72) Inventor: Rickard Ljung, Helsingborg (SE)

(73) Assignee: SONY MOBILE COMMUNICATIONS AB, Lund (SE)

(21) Appl. No.: 13/525,865

(22) Filed: Jun. 18, 2012

(51) Int. Cl. H04W 52/02; H04W 88/02

(52) U.S. Cl. 455/458; 455/574

(57) ABSTRACT

Enhanced idle mode signal reduction signaling within two network cells is performed by a terminal to determine whether to initiate a PLMN scan measurement. A terminal receives a network controlled signal threshold T1, which is the threshold signal quality below which the terminal is expected to initiate PLMN scan measurements to find a more suitable cell. The terminal generates a terminal controlled signal T2, which is the threshold signal quality below which the terminal is unable to decode signals of the network cells. When the signals of the network cells satisfy T2, dual standby paging is activated. In addition, a PLMN scan measurement is made only when the signal quality on both network cells falls below T1. Because a PLMN scan measurement is made only when the signal quality on both network cells falls below T1, the number of PLMN scan measurements is reduced substantially and power efficiency is enhanced.

### TECHNICAL FIELD OF THE INVENTION

The technology of the present disclosure relates generally to portable electronic devices operable on a cellular network, and more particularly to a system and methods for reducing power consumption in a cellular device by improving network selection using an enhanced idle mode signal reduction processing with a dual standby configuration.

### DESCRIPTION OF THE RELATED ART

Portable electronic devices that operate on a cellular network, such as mobile telephones and smartphones, tablet computers, cellular-connected laptop computers, and similar devices are ever increasing in popularity. When a new radio access system or technology is introduced into a mobile communications network, the number of activated cells utilizing the new radio access technology typically gradually increases over time as the new technology is adopted, starting with a relatively small number of activated cells at initial launch. For example, currently new “4G” radio access technology is gradually replacing more conventional “3G” technology, although at this time the majority of cellular devices are still operating within 3G network systems.

In terms of network coverage, this will likely result in a scenario in which initially there are relatively large areas without stable coverage from the new radio access system, and it follows only a smaller amount of total land area with acceptable network coverage. Under such circumstances, in which a certain either new or highly prioritized radio access technology has only limited and scattered coverage, but the same network provider also has another network with more active cells and therefore better coverage, it is likely that terminals camping in that operator network supporting both access technologies will face a network selection challenge.

Typically, it would be preferred for active cells to operate within the new radio access system as being more technologically advanced, and possibly also having more available system capacity. Accordingly, the network selection challenge may include a built-in network selection preference for the new radio access technology, although the terminal often during its idle mode paging will experience poor signal quality from the new network. Conventionally, when a terminal in idle mode determines that a network has poor signal quality, the terminal initiates Public Land Mobile Network (PLMN) search or scan measurements to find a more suitable cell within the same or another network. For illustration purposes, a network-based poor signal quality threshold is denoted herein as “T1”. If the signal quality were to fall below T1, the cellular device will risk being unable to access the network, and the terminal is therefore instructed to start a PLMN scan in order to find a more suitable cell if possible. Parameters defining T1 are cell specific information broadcasted and controlled by network. In other words, T1 consists of one or more network parameters that determine criteria for when network signal quality is at such a low level that the terminal is at risk of not being able to operate on the network. If such signal quality indeed falls below T1, it is assumed to be highly probable that a more suitable cell will use a legacy network technology, due to the fewer amounts of new cells and thus a smaller coverage area of the higher prioritized network. Accordingly, after cell reselection to the legacy cell with better signal quality, the terminal will initiate neighbor cell PLMN scan measurements again searching for cells using the new network, striving to follow the built-in preference of accessing the new higher prioritized network when possible.

For example, the new higher prioritized network could be a new “4G” Long Term Evolution (LTE) network being rolled out by a cellular network operator that already has GSM and/or WCDMA “3G” networks. The operator prefers cell terminals to camp on the new LTE network to provide high data throughput and capacity, but the coverage of the new LTE network may be significantly worse or narrower than the legacy GSM/WCDMA network. Such circumstances can result in a ping-pong situation with a significant amount of both PLMN scan measurements and cell reselection signaling. The reason for high cell reselection signaling is that such signaling is needed whenever a terminal is switching access technology. This is because conventional network configurations had always needed to be aware of which area of cells (called a routing area (RA) in GSM/WCDMA and tracking area (TA) in LTE) a terminal is camping on and therefore should be paged within, such as when a phone call or other communication is initiated that terminates in the terminal.

The combined and repeated need to initiate PLMN scan measurements and related network reselection signaling results in substantial drain of the battery power. One option to reduce the number of PLMN scan measurements and network reselection signaling would be to lower the threshold of acceptable signal strength T1 of the new network. This would reduce the amount of PLMN scan measurements and cell reselections, since T1 defines at what quality threshold such measurements are to begin. Such a solution, however is undesirable because it would likely have a severe negative impact on mobility support and call setup ratios, since thresholds for initiating neighbor cell measurements are optimized for new cells to typically be detected before out of service is reached, and at levels where the probability to setup a connection still is very high. So in practice, the T1 thresholds need to be as high as practicable and cannot be significantly adjusted to avoid the ping-pong effect referenced above.

An improvement to reduce the amount of cell reselection signaling has been introduced in the standard 3GPP Release 8 by means of the concept called “Idle Mode Signaling Reduction” (ISR). With ISR, the network can allow a terminal to simultaneously be registered in a 3G routing area and an LTE tracking area. When a communication is received, paging under ISR goes over both networks so a device does not specifically need to be camped in either one network or the other. Accordingly, a terminal will not need to initiate a cell reselection signaling for a tracking area update or routing area update during these access technology switches, and the network paging occurs in both networks regardless of in which specific network the terminal may be operating. In other words, by paging in both networks, the network does not need or care to “know” in which network the terminal is operating.

In conventional ISR, however, although network paging occurs in both networks, the terminal device itself is only “listening” on one network at a time. For example, although the network may be paging on both 3G and LTE networks, due to coverage issues the device may respond on the 3G network. As such, the terminal will continue to generate PLMN scan measurements so as to attempt to detect the higher prioritized LTE network. Accordingly, ISR processing itself does not avoid the substantial battery draining caused by frequent PLMN scan measurements. These measurements are independent of the signal paging from the network, so the PLMN scan measurements are still required to be started every time the terminal experiences poor signal quality, particularly in the new network having relatively smaller coverage areas as compared to the legacy network. Thus, although the ISR processing can help reduce the high reselection signaling load, it will not help terminals reduce the battery-draining PLMN scan measurements.

Another option has been to provide terminals with two different SIM cards, which essentially constitute two different network identities (accounts, phone numbers, etc.) for the same terminal. One such identity may be a 3G identity and another identity may be a 4G LTE identity. With two identities, the same terminal may be operating in both networks. Modems in terminal devices also may have the capability to simultaneously camp on two different networks, still using only one modem and one radio. The dual camping principle is based on the operation that the terminal in a time slot manner wakes up from idle and listens to paging in two different cells. Again, this capability conventionally has been used for so-called “dual SIM dual standby” operation in terminals that are capable of reading two SIM-cards and thereby camp in two networks as two separate identities. The need for two different identities, however, can be burdensome and expensive for the user and has thus proved to be an inadequate solution to the issue of reducing PLMN scan measurements

In view of the above, the ping-pong effect caused by a new network with relatively poor coverage in a multimode environment, even using ISR, will drain a significant amount of battery power, because of the continued need to perform frequent neighbor cell PLMN scan measurements.

### SUMMARY

To improve the consumer experience with portable electronic devices connected to a cellular network, there is a need in the art for an improved system and methods for reducing power consumption in a cellular terminal electronic device by improving network selection with reduced need for PLMN scan measurements. The present invention provides improved battery consumption by reducing the number of PLMN scan measurements for terminals in an idle mode by enhanced ISR combined with a dual cell standby paging operation.

The present invention provides systems and methods for performing enhanced idle mode signal reduction signaling to determine whether to initiate a PLMN scan measurement. In accordance with exemplary embodiments, a terminal receives a network controlled signal threshold T1, which is the threshold signal quality below which the network conventionally would request the terminal to initiate a PLMN scan measurement to try to find a more suitable cell. In addition, the terminal generates a terminal controlled signal threshold T2, which is the threshold signal quality below which the terminal is unable to decode signals of the network cells.

The terminal determines if at least two network cells on different networks have respective signal qualities that satisfy the threshold T2. If so, a dual standby processing is activated, and paging occurs for both of the first and second network cells. In addition, a PLMN scan measurement is made only if the signal quality on both network cells falls below T1. So long as both network cell signal qualities remain above T2, such that the terminal can still decode both network cell signals, the dual standby state can be maintained and the terminal can receive paging over both network cells even if the signal quality on one of the network cells falls below T1. Because a PLMN scan measurement is made only if the signal quality on both network cells falls below T1, the number of PLMN scan measurements is reduced substantially as compared to conventional configurations. The result is a substantial enhancement of power efficiency, which in turn substantially extends battery life.

Accordingly, an aspect of the invention is a cellular terminal electronic device. In an exemplary embodiment, the cellular terminal electronic device includes a modem having a radio circuit configured to receive a first signal from a first network cell and a second signal from a second network cell. The first network cell and the second network cell are on different networks, and the radio circuit further is configured to receive a network controlled threshold corresponding to a signal below which the terminal does not operate within the network cells. A signal quality determination section is configured to determine a signal quality of each of the first and second signals, and a terminal controlled threshold generator is configured to generate a terminal controlled threshold corresponding to a signal below which the terminal cannot decode the signals of the first and second network cells. A comparator module is configured to determine whether the signal qualities of both the first and second signals exceed the terminal controlled threshold, and when the signal qualities of both the first and second signals exceed the terminal controlled threshold the comparator module activates dual standby paging. The comparator module is further configured to determine whether the signal qualities of both the first and second signals fall below the network controlled threshold, and when the signal qualities of both the first and second signals fall below the network controlled threshold, the comparator module outputs an initiation signal for initiation of a public land mobile network (PLMN) scan measurement.

In an exemplary embodiment of the cellular terminal electronic device, the terminal controlled threshold generator generates a terminal controlled threshold that is less than the network controlled threshold.

In an exemplary embodiment of the cellular terminal electronic device, the terminal controlled threshold generator terminal controlled threshold is at least 10dB less than the network controlled threshold.

In an exemplary embodiment of the cellular terminal electronic device, the cellular terminal electronic device further includes a PLMN scanner configured to receive the initiation signal from the comparator module and in response to the initiation signal, perform a PLMN scan.

In an exemplary embodiment of the cellular terminal electronic device, the radio circuit is configured to receive paging in the first network cell and the second network cell during dual standby paging.

In an exemplary embodiment of the cellular terminal electronic device, the cellular terminal electronic device further includes a non-transitory computer readable medium storing computer program code which when executed comprises the signal quality determination section, the terminal controlled threshold generator, and the comparator module. A controller is configured to execute the program code stored on the non-transitory computer readable medium.

Another aspect of the invention is a communications system that includes the described cellular terminal electronic device, a first network that includes the first network cell, and a second network that includes the second network cell, wherein the first network is different from the second network.

In an exemplary embodiment of the communications system, the first network cell is on a legacy network and the second network cell is on a higher prioritized network.

In an exemplary embodiment of the communications system, the legacy network is a 3G network and the higher prioritized network is a 4G Long Term Evolution (LTE) network.

Another aspect of the invention is a method of performing enhanced idle mode signal reduction signaling with a cellular terminal electronic device. In an exemplary embodiment, the method includes the steps of receiving a first signal from a first network cell and a second signal from a second network cell, wherein the first network cell and the second network cell are on different networks; determining a signal quality of each of the first and second signals; receiving a network controlled threshold corresponding to a signal below which the terminal is expected by the network to start finding a more suitable cell within which to operate; generating a terminal controlled threshold corresponding to a signal below which the terminal cannot decode the signals of the first and second network cells; determining whether signal qualities of both the first and second signals exceed the terminal controlled threshold, and when the signal qualities of both the first and second signals exceed the terminal controlled threshold, activating dual standby paging; determining whether the signal qualities of both the first and second signals fall below the network controlled threshold; and when the signal qualities of both the first and second signals fall below the network controlled threshold, performing a public land mobile network scan (PLMN) measurement.

In an exemplary embodiment of the method, the first network cell is on a legacy network and the second network cell is on a higher prioritized network.

In an exemplary embodiment of the method, the legacy network is a 3G network and the higher prioritized network is a 4G Long Term Evolution (LTE) network.

In an exemplary embodiment of the method, the first network cell is within a routing area of the 3G network and the second network cell is within a tracking area of the 4G LTE network.

In an exemplary embodiment of the method, the terminal controlled threshold is less than the network controlled threshold.

In an exemplary embodiment of the method, the terminal controlled threshold is less than the network controlled threshold.

In an exemplary embodiment of the method, the terminal controlled threshold is at least 10 dB less than the network controlled threshold.

In an exemplary embodiment of the method, the network controlled threshold is different for each of the first signal and the second signal.

In an exemplary embodiment of the method, the terminal controlled threshold is different for each of the first signal and the second signal.

In an exemplary embodiment of the method, when it is determined that only one of the first signal or second signal falls below the network controlled signal, maintaining the dual standby paging.

In an exemplary embodiment of the method, when it is determined that one of the first signal or second signal falls below the terminal controlled signal, entering a single network standby mode.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a graphical depiction of paging operations by two networks in a dual standby operation.

FIG. 2 is a graphical depiction of dual standby operation of a terminal in accordance with signal quality on two different networks.

FIG. 3 is a flow chart depicting an exemplary method of performing enhanced idle mode signal reduction signaling to determine whether to initiate a PLMN scan measurement.

FIG. 4 is a schematic view of a mobile telephone as an exemplary cellular terminal electronic device for use in accordance with embodiments of the present invention.

FIG. 5 is a schematic block diagram depicting operative portions of the mobile telephone of FIG. 4.

FIG. 6 is a schematic block diagram depicting operative portions of an exemplary configuration of module components of an enhanced ISR/Dual Standby Application in accordance with embodiments of the present invention.

FIG. 7 is a schematic diagram of a communications system in which the mobile telephone of FIG. 4 may operate.

### DETAILED DESCRIPTION OF EMBODIMENTS

As described in more detail below, the present invention provides an enhanced dual standby process by which the terminal can listen for network paging both from a first network and a second network. The first network may be a legacy network, such as for example a 3G network. The second network may be a higher prioritized network, such as for example a 4G LTE network. The present invention provides for an enhanced dual standby process that does not require any additional hardware in the terminal, such as utilized in conventional dual SIM card slot configurations, and thus the present invention does not have the drawbacks of assuming dual terminal identities.

Embodiments of the present invention will now be described with reference to the drawings, wherein like reference numerals are used to refer to like elements throughout. It will be understood that the figures are not necessarily to scale.

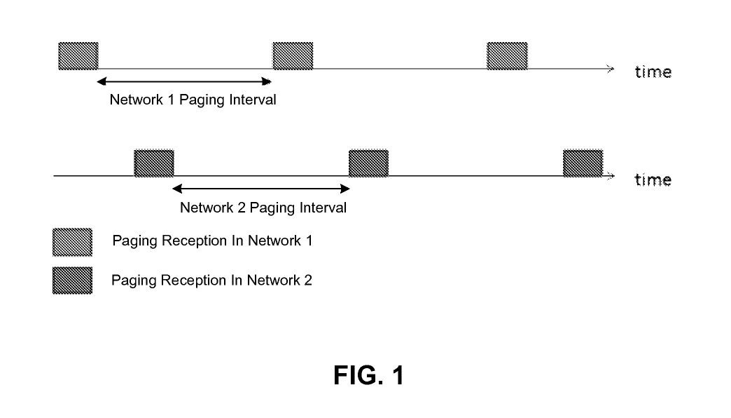

The present invention improves upon the conventional dual standby functionality, described above. Conventional terminal modems of today typically have the capability to run an algorithm to simultaneously camp on two different networks while still using only one modem and one radio circuit. The terminal in a time slot manner wakes up from idle and listens to paging within two different cells. A general illustration of this dual standby functionality is shown in FIG. 1. This dual standby functionality, as referenced above, may be employed in a dual SIM card configuration in terminals that are capable of reading two SIM cards and thereby camp in two networks as two separate identities. In contrast, the present invention does not require any additional hardware in the terminal for dual SIM card slots, and the terminal in the present invention therefore does not assume double terminal identities. Rather, the modem in the terminal of the present invention performs a dual standby operation using a built-in algorithm to alternate between paging readings on two different network cells.

FIG. 1 is a graphical depiction of paging operations by two networks in a dual standby operation. As depicted in FIG. 1, in a dual standby operation the terminal camps on both networks 1 and 2. The modem thus may receive paging in both network 1 and network 2. The paging for each network occurs sequentially as depicted in the figure, and with respective paging intervals over time.

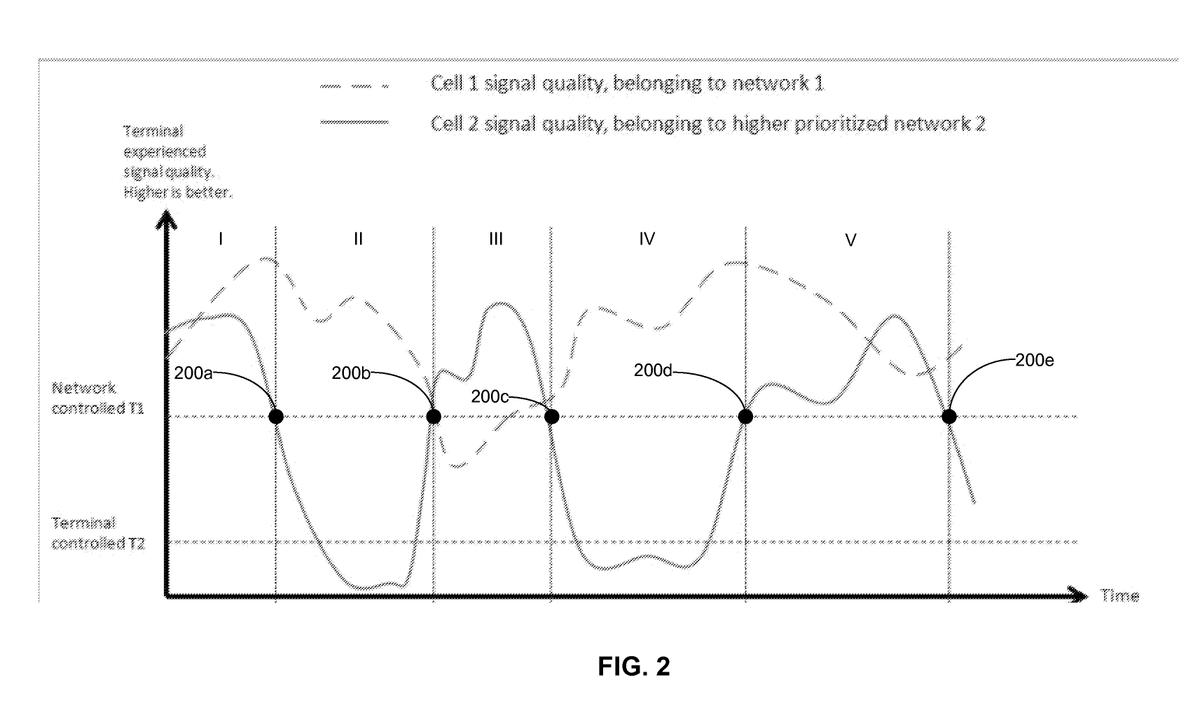

FIG. 2 is a graphical depiction of dual standby operation of a terminal in accordance with signal quality on two different networks. The terminal operation is initiated by ISR activation based on a conventional base station signaling protocol. Thus, at a certain scenario identified by the network, the base station signaling initiates an “idle mode signaling reduction” functionality, or ISR as referenced herein. In the example of FIG. 2, Cell 1 represents a cell on a first network that is, for example, a legacy network with a relatively high coverage area. Cell 2 represents a cell on a second network that is a higher prioritized network, but which typically would have a smaller coverage area as compared to the coverage area of Cell 1. For example, in terms of 3GPP functionalities, the terminal may be added by the network system to both a GSM/WCDMA routing area (represented as Cell 1 in FIG. 2) and an LTE tracking area (represented by Cell 2 in FIG. 2). Accordingly, when the terminal receives the ISR activation, the terminal activates its capability for dual standby operation, targeting to camp on both a GSM/WCDMA cell and an LTE cell. Because the terminal receives the ISR information and thus camps on both Cell 1 and Cell 2, the terminal will not initiate cell reselection signaling when moving between cells belonging to these areas in accordance with ISR protocols.

In the example of FIG. 2, the dashed line represents the signal quality for Cell 1 over time, and the solid line represents the signal quality for Cell 2 over time. As depicted in FIG. 2, the signal quality of the cells is associated with two thresholds. A first threshold T1 is a network controlled threshold that was referenced above. If the signal quality were to fall below T1, the cellular device will be in risk to be unable to access the network. In other words, T1 is a network parameter that determines at what network quality threshold it is expected that the terminal would initiate PLMN scan measurements in order to find a more suitable cell. Hence, the network is configured to require the terminal to initiate PLMN scan measurements at still relatively fair receiver conditions so as not to risk entering into an out-of-coverage scenario. Accordingly, although as a network parameter a terminal is not expected to utilize a cell for much longer if the signal quality falls below T1, the terminal typically remains able to decode signals well below the signal quality of T1. Conventionally, the terminal can often decode signals and utilize the cell even if signal quality falls to 10 to 15 dB below the T1 threshold.

As depicted in FIG. 2, embodiments of the present invention utilize a second signal quality threshold T2. T2 is a terminal controlled threshold that corresponds to a minimum signal quality below which a terminal can no longer decode signals of a corresponding cell on the network. Whenever the signal quality of one or more current cells is higher than the terminal-defined or controlled threshold T2, such cells are visible and decodable by the terminal. In the specific example of FIG.2, when both signals of Cell 1 and Cell 2 are above T2, the terminal will continue receiving paging on both the Cell 1 within a GSM/WCDMA routing area and Cell 2 within an LTE tracking area. This simultaneous paging information reception means that as long as the terminal remains capable of decoding the signals on both cells (satisfying the T2 threshold), and at least one of the signals satisfies the conventional network controlled cell quality threshold T1, there will not be any initiation of battery draining PLMN scan measurements. Battery power, therefore, is conserved as compared to conventional systems that either would only camp on one cell or had utilized dual SIM dual standby functionality.

More specifically, the enhanced operation of the present invention results from the typically substantial difference between the thresholds T1 and T2. As referenced above, a terminal can often decode signals even if the signal quality were to fall 10 to 15 dB below the T1 threshold. In other words, threshold T2 typically may be as much as 15 dB, and preferably at least 10 dB, below the threshold T1. FIG. 2 depicts signal quality in a given geographical region that is within the potential coverage area of a legacy (for example GSM or WCDMA) macro Cell 1 denoted as a first network 1, and a higher prioritized (for example LTE) macro Cell 2 denoted as a second network 2. Network 1, as a legacy network, typically will have a relatively more stable and favorable reception and as compared to the higher prioritized network 2. Conversely, network 2 will tend to have a relatively weaker signal and scattered coverage within the given geographical region as compared to network 1. Based on FIG. 2, the operation of a conventional terminal may be compared with the enhanced operation of the present invention with respect to the need for initiating the power draining PLMN scan measurements.

FIG. 2 is divided into five regions labeled I-V for convenience, with illustrative inflection points denoted by reference numerals 200a-e. It is presumed that the terminal is operating in a dual standby mode that has been activated by ISR initiation. As explained in detail below, in the present invention the terminal will never initiate a PLMN scan measurement in the example of FIG. 2. In contrast, a conventional terminal operating under conventional ISR will initiate at least five such PLMN scan measurements at each of the inflection points 200a-e. The terminal of the present invention, therefore, will have substantially enhanced power consumption efficiency as compared to a conventional terminal.

The operation of conventional terminals prior to the present invention is as follows. Generally, the terminal operates in accordance with a preference for the higher prioritized Cell 2. Accordingly, in regions I and V in which the signal quality of both signals is above the network controlled threshold T1, the conventional terminal will camp and operate within Cell 2. In addition, in region III in which only Cell 2 has a signal quality above T1 (which actually would be a rare occurrence because of the greater coverage of Cell 1), the conventional terminal again will camp and operate in Cell 2. In regions II and IV, in which the signal quality of Cell 2 has fallen below T1, the conventional terminal will camp and operate within the legacy Cell 1.

In the operation of the conventional terminal, whether or not the terminal camps on a particular cell is determined only based on the signal quality relative to the network controlled threshold T1. In particular, the conventional terminal will no longer target to camp on Cell 2 when the signal quality of Cell 2 falls below the network controlled threshold T1. Accordingly, given the prioritization of Cell 2 over Cell 1, the conventional terminal will initiate a PLMN scan measurement every time the terminal initially is camping on Cell 2 but the signal quality of Cell 2 subsequently falls below the network controlled threshold T1. This is likely to happen often insofar as the higher prioritized network (e.g., LTE) will have relatively weak coverage as compared to the legacy network (e.g., 3G) for a substantial time period after the initial rollout of the higher prioritized network.

Referring to FIG. 2, for example, a PLMN scan measurement will be initiated by the conventional terminal at inflection points 200a, 200c, and 200e, insofar as the signal quality of Cell 2 falls below T1 and the terminal will attempt to detect the higher prioritized network Cell 2. In addition, so long as Cell 2 remains below the network controlled threshold T1, the conventional terminal will initiate a periodic PLMN scan measurement to periodically attempt to detect the higher prioritized network of Cell 2. Referring again to FIG. 2, for example, the conventional terminal will initiate a PLMN scan measurement at or around inflection points 200b and 200e until a signal quality of Cell 2 above T1 is detected. In this regard, although only two such PLMN scan measurements 200b and 200e are shown in FIG. 2, it will be appreciated that the conventional terminal will continue to perform any number of periodic PLMN scan measurements as needed until a signal quality of Cell 2 above T1 is detected, which will be a substantial drain of battery power. Of course, the conventional terminal will also perform a PLMN scan measurement every time the time the terminal is camping on the legacy network of Cell 1 and the signal quality of Cell 1 falls below T1, although this normally will not occur often as the legacy network of Cell 1 should have high coverage.

The present invention is in contrast to the operation of the conventional terminal described above. In the present invention, whether or not the terminal camps on a particular cell is determined based on the signal quality relative to both the network controlled threshold T1 and the terminal controlled threshold T2. Generally, the terminal of the present invention first determines whether there are at least two cells from different networks that satisfy the terminal controlled threshold T2. If so, this would mean that signals of at least two different networks are decodable by the terminal. Under such circumstances, the terminal camps on both the first and second networks and can receive paging from both networks. In addition, so long as at least one cell of one of the networks maintains a signal quality above the network controlled threshold T1, no PLMN scan measurement will be performed. Rather, a PLMN scan measurement is performed only if both terminals fall below the network controlled threshold T1. Referring to FIG. 2 above, in accordance with the operation of the present invention, the terminal will not perform any PLMN scan measurements, insofar as at least one of the network cells always has a signal quality above the network controlled threshold T1. This is in contrast to the conventional terminal as described above, which will perform multiple PLMN scan measurements (at least at each of inflection points 200a-e). The present invention, therefore, will achieve enhanced battery power performance by substantially reducing the number of power draining PLMN scan measurements that need to be performed.

The operation of the present invention still permits full mobility support. When both the legacy cell (e.g., 3G GSM/WCDMA) and the higher prioritized cell (e.g., 4G LTE) have signal quality lower than their respective T1 thresholds, PLMN scan measurements are started. Following normal ISR procedure, this behavior is maintained as long as ISR is active and the terminal stays within the same routing area and tracking area. When the routing area or tracking area needs to be updated based on prioritization of the cells, cell reselection signaling is performed. Accordingly, the conventional network and 3GPP protocol is not affected by the terminal behavior of the present invention. The terminal can select for itself which network to utilize for terminal originated and terminated connections. In addition, the network still will not “know” that the terminal can be listening to both networks, and according to ISR standards the network will continue to transmit terminal paging information within both networks.

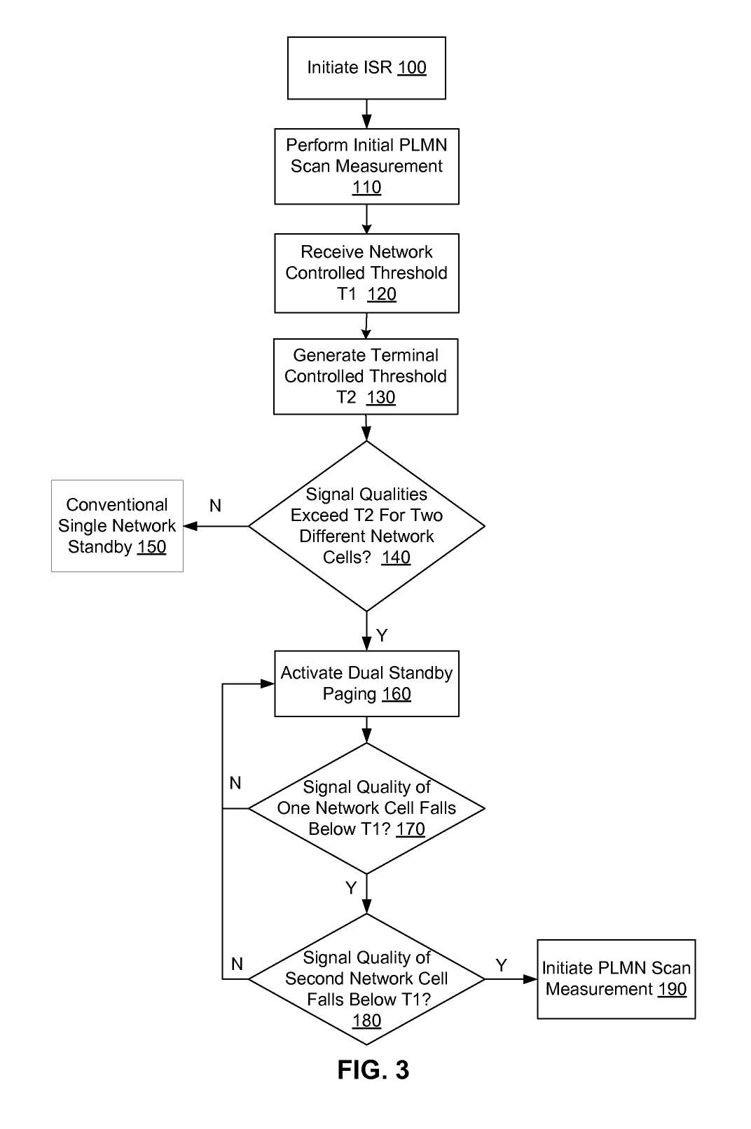

In accordance with the above features, FIG. 3 is a flow chart depicting an exemplary method of performing enhanced idle mode signal reduction signaling to determine whether to initiate a PLMN scan measurement. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 100, in which idle mode signal reduction (ISR) is initiated. Insofar as ISR is initiated, those of ordinary skill in the art will understand that the method presumes base station signal protocols have determined that a terminal may be in both a first network cell for a first network (such as a 3GPP GSM/WCDMA routing area), and a second network cell for a second network that is different from the first network (such as a 4G LTE tracking area). ISR would not need to be utilized in the event only a single network cell, or multiple cells but only on the same network, would be available.

At step 110, the terminal performs an initial PLMN scan measurement so that the terminal initially can determine that the first and second network cells that are eligible for communication. At step 120, the terminal receives a network controlled signal threshold T1 from the networks, which, as referenced above, is the threshold signal quality below which the terminal is expected by the network to search for a more suitable cell so as not to risk losing the communication capability with the network. T1 may be the same for both cells of each of the first and second networks, as depicted in FIG. 2, or T1 may be different for each of the first network cell and the second network cell. At step 130, the terminal generates a terminal controlled signal threshold T2, which, as referenced above, is the threshold signal quality below which the terminal is unable to decode signals of the network cells. Similarly as to T1, T2 may be the same for both cells of each of the first and second networks as depicted in FIG. 2, or T2 may be different for each of the first network cell and the second network cell.

At step 140, the terminal determines if at least two network cells on different networks have respective signal qualities that satisfy the threshold T2. When not, this means that signals from at most only one of the networks is decodable by the terminal at all. Accordingly, the method would end at step 150, in which the terminal would operate pursuant to conventional single network standby protocols. In other words, only one network is sensed at all. This would occur, for example, in a geographic region in which only the legacy network (e.g., 3G) has coverage, and coverage for the higher prioritized network (e.g., LTE) would as not yet be available. Step 150 would encompass both the situation when at most only one network signal is decodable at the outset, and if the signal quality of one of the networks should fall below T2 such that at most only one network cell becomes decodable.

Alternatively, under the processing of the present invention, at step 140 it is determined that at least two network cells on different networks have respective signal qualities that satisfy the threshold T2. Under such circumstances, the method proceeds to step 160, at which dual standby is activated. Paging now occurs for both of the first and second network cells of the respective first and second networks. In step 170, a determination is made as to whether the signal quality of one of the network cells has fallen below the network controlled threshold T1. When both signal qualities remain above T1 (a “No” determination in step 160), then the dual standby mode entered into at step 160 remains. When, however, one of the signal qualities has fallen below T1, then the method proceeds to step 180. Typically, the higher prioritized network cell would be the more likely of the two to fall below threshold T1 because, as stated above, the legacy network typically would have broader coverage.

At step 180, a determination is made as to whether the signal quality of the second cell of the second network has fallen below T1. As described above with reference to FIG. 2, a PLMN scan measurement is made only when the signal quality on both network cells falls below T1. Accordingly, when a “No” determination is made at step 180, indicating that the signal quality of the second network cell remains above T1, then the dual standby state is maintained as before. Assuming that both network cell signal qualities remain above T2, such that the terminal can still decode both network cell signals, the dual standby state can be maintained and the terminal can receive paging over both network cells as before. On the other hand, when a “Yes” determination is made at step 180, indicating that the signal quality of both network cells is below T1 (the network controlled threshold), this means that the terminal is no longer expected by the network to operate within either network cell. Under such circumstances, the method proceeds to step 190, and a PLMN scan measurement is initiated to attempt to detect a network cell signal above T1 that would permit the terminal to operate within the corresponding network cell.

As referenced above, operation in accordance with the present invention will save battery power as compared to conventional operation. The amount of battery savings will be modem, network, and consumer dependent. Generally, the required instantaneous computational complexity, and thereby instantaneous power consumption for a complete PLMN scan measurement, is at least on the order of 1-2 times the instantaneous complexity of decoding paging information from a known cell. A PLMN scan typically requires at least five seconds of continuous activity, while the active radio time for paging a known cell is approximately 50 ms. A normal paging interval is 1.28 s, meaning that in one minute the active radio time for the additional dual standby paging would be 2.3 seconds. Hence, terminal will save power as long as the intervals between additional PLMN scans are 2-4 minutes. In a typical mobile scenario, therefore, the battery powers savings of the claimed invention should be substantial.

In exemplary embodiments, to improve the probability for significant power consumption savings, triggering the dual standby operation described above may occur only when it is first determined that a terminal is experiencing a magnitude of variation in the signal quality above a signal stability threshold, which may be a predetermined threshold. If the signal quality is very stable and thus above the signal stability threshold, one can assume that the terminal is in a non-mobile use case. No significant additional measurements would be required for this trigger analysis, since signal quality typically is measured at every paging instant.

The above functionality may be performed by the radio functionality components of a portable communication device that can act as a cellular terminal. Such components may include a modem incorporating a radio circuit and connected to an antenna, and a controller device. The following description of such a cellular terminal electronic communication device is made in the context of a mobile telephone. It will be appreciated that the invention is not intended to be limited to the context of a mobile telephone and may relate to any type of appropriate electronic device that can operate over a cellular network, examples of which include various types of smartphones, laptop computers, tablet computing devices, personal digital assistants, and the like. For purposes of the description herein, therefore, the interchangeable terms “electronic equipment” and “electronic device” include any suitable portable radio communication equipment or a mobile radio terminal.

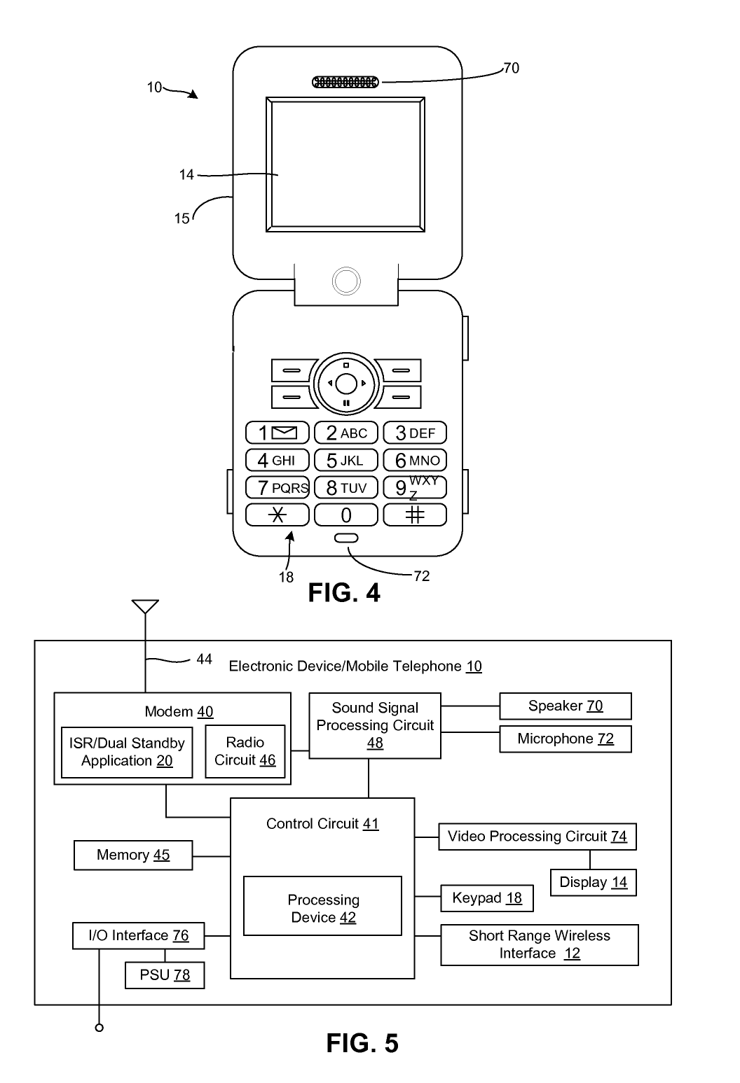

Referring to FIGS. 4 and 5, an exemplary cellular terminal electronic device in the form of a mobile telephone 10 is described, which is configured to perform enhanced idle mode signal reduction signaling to determine whether to initiate a PLMN scan measurement. In particular, FIG. 4 is a schematic diagram depicting an exemplary mobile telephone 10 in accordance with embodiments of the present invention. FIG. 5 depicts a functional block diagram of operative portions of the mobile telephone 10 of FIG. 4. Mobile telephone 10 may be a clamshell telephone with a flip-open cover 15 movable between an open and a closed position. In FIG. 1, the cover is shown in the open position. It will be appreciated that mobile telephone 10 may have other configurations, such as a “block” or “brick” configuration, a slide or swivel cover configuration, or other configurations as are known in the art.

As depicted in FIG. 5, mobile telephone 10 has a modem 40 that includes a radio circuit 46 and is connected to an antenna 44, and an ISR/Dual Standby Application 20. For performing various types of communications, the radio circuit 46 includes call circuitry that enables the mobile telephone 10 to establish a call and/or exchange signals with a called/calling device, typically another mobile telephone or landline telephone, or another electronic device. Thus, the radio circuit 46 includes a radio frequency transmitter and receiver for transmitting and receiving signals via the antenna 44 as is conventional. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 further includes a primary control circuit 41 that is configured to carry out overall control of the functions and operations of the mobile telephone 10. The control circuit 41 may include a processing device 42, such as a CPU, microcontroller or microprocessor. Among their functions, to implement the features of the present invention, the control circuit 41 and/or processing device 42 may comprise a controller that may execute program code embodied as the ISR/Dual

Standby Application 20. It will be apparent to a person having ordinary skill in the art of computer programming, and specifically in application programming for mobile telephones or similar other portable electronic devices, how to program a mobile telephone to operate and carry out logical functions associated with application 20. Accordingly, details as to specific programming code have been left out for the sake of brevity. Also, while the code may be executed by control circuit 41 and/or processing device 42 in accordance with an exemplary embodiment, such controller functionality could also be carried out via dedicated hardware, firmware, software, or combinations thereof, without departing from the scope of the invention.

The controller or control device constituting control circuit 41 and/or processing device 42, therefore, may be configured to perform enhanced idle mode signal reduction signaling to determine whether to initiate a PLMN scan measurement by execution of the program code embodied as the ISR/Dual Standby Application 20. As depicted in FIG. 5, the controller may be a separate component from the modem 40 and may be incorporated as part of the general control functionality of the mobile telephone 10. Alternatively, a comparable control device may be incorporated into the modem 40 itself. Similarly, the application 20 is depicted in FIG. 5 as being incorporated into the modem 40, and in such configuration would be stored on an internal memory of the modem. Alternatively, the application 20 may be separate from the modem 40, and may be stored on other memory components of the mobile telephone 10, such as for example the memory 45. Accordingly, the invention is not intended to be limited to any specific configuration of the various components within the mobile telephone 10, and accordingly the component configuration may be varied without departing from the scope of the invention.

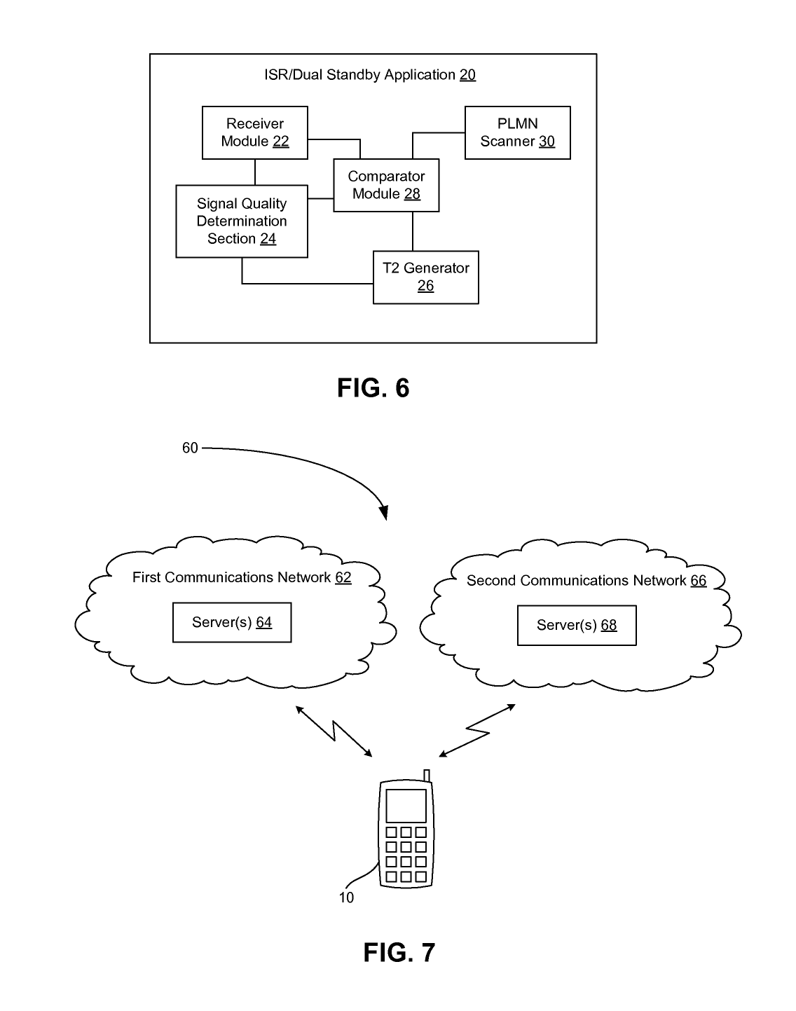

FIG. 6 is a schematic block diagram depicting operative portions of an exemplary configuration of module components of the ISR/Dual Standby Application 20. As referenced above more generally, the various modular components of the application 20 may be implemented as dedicated hardware, firmware, software, or combinations thereof.

The application 20 may include a receiver module 22 that can receive incoming signals from one or more networks cells. In particular, in accordance with the above description, the receiver module is configured to receive at least a first signal from a first network cell, and a second signal from a second network cell. The first network including the first network cell, for example, may be a legacy network such as a 3GPP network. The second network including the second network cell is different from the first network, and, for example, may be a higher prioritized network, such as an LTE network (or vice versa). The receiver module 22 also is configured to receive the network controlled threshold T1. As stated above, T1 is a network parameter and is the signal quality threshold below which the terminal is not expected to continue to operate on a network for much longer, and instead start searching for a cell with better received signal quality, and may be the same or different as between the first and second networks.

In exemplary embodiments, the receiver module may constitute the radio circuit 46 of the modem, and is configured to receive the first signal from the first network cell and the second signal from the second network cell, wherein the first network cell and the second network cell are on the different networks. In such embodiment, the radio circuit 46 further is configured to receive the network controlled threshold T1 corresponding to the signal below which the terminal is not permitted to operate within the network cells.

The application 20 also may include a signal quality determination section 24. The determination section 24 is configured to determine the signal qualities of the received signals from the first and second network cells. The application 20 also may include a terminal controlled threshold generator, or T2 generator, 26 that is configured to generate the terminal controlled threshold T2. As stated above, T2 is a terminal parameter and is the signal quality threshold below which the terminal cannot decode a signal coming from a network, and may be the same or different as between the first and second networks.

The application 20 also may include a comparator module 28. The comparator module 28 is configured to compare the signal qualities as determined by the determination section 24 to the received network threshold T1 and the terminal generated threshold T2. More specifically, the comparator module is configured to perform the comparison as described above so as to perform, when executed by the controller or control device 41/42, the enhanced idle mode signal reduction signaling to determine whether to initiate a PLMN scan measurement. Thus, the comparator module 28 is configured to determine whether the signal qualities of both the first and second signals exceed the terminal controlled threshold T2, and when both the first and second signals exceed the terminal controlled threshold T2 the comparator module activates the dual standby paging. The radio circuit 46 is configured to receive paging in the first network cell and the second network cell during the dual standby paging. The comparator module 28 further is configured to determine whether the signal qualities of both the first and second signals fall below the network controlled threshold T1, and when both the first and second signals fall below the network controlled threshold T1, the comparator module outputs an initiation signal for initiation of a PLMN scan measurement.

In other words, the result of the operations of the comparator module 28 is a determination as to whether to initiate a PLMN scan measurement. The application 20 also may include a PLMN scanner 30. If the comparator module 28 determines that a PLMN scan measurement should be initiated, the comparator outputs an initiation signal to the PLMN scanner 30. The PLMN scanner 30 is configured to receive the initiation signal from the comparator module 28 and in turn performs a PLMN scan measurement.

Referring to FIG. 7, the mobile telephone 10 may be configured to operate as part of a communications system 60. The communications system 60 may include a first communications network 62 having a server 64 (or servers) for managing calls placed by and destined to the mobile telephone 10, transmitting data to the mobile telephone 10 and carrying out any other support functions. The communications system 60 also may include a second communications network 66 having a server 68 (or servers) also for managing calls placed by and destined to the mobile telephone 10, transmitting data to the mobile telephone 10 and carrying out any other support functions. The first and second communications networks 62 and 66 may correspond to the first and second networks referenced elsewhere herein, which include the first network cell and the second network cell. One or the first communications network including the first network cell may be a legacy network (e.g., 3G/3GPP), and the other or second communications network including the second network cell may be a higher prioritized network (e.g., 4G/LTE).

The servers 64 and 68 communicate with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The networks 62 and 66 may support the communications activity of multiple mobile telephones 10 and other types of end user devices. As will be appreciated, the servers 64 and 68 may be configured as a typical computer system used to carry out server functions and may include a processor configured to execute software containing logical instructions that embody the functions of the servers 64 and 68 and a memory to store such software.

In accordance with the above description, an aspect of the invention is a cellular terminal electronic device. The cellular terminal electronic device includes a modem that has a radio circuit configured to receive a first signal from a first network cell and a second signal from a second network cell, wherein the first network cell and the second network cell are on different networks. The radio circuit further is configured to receive a network controlled threshold corresponding to a signal below which the terminal is not permitted to operate within the network cells.

The cellular terminal electronic device also includes a signal quality determination section configured to determine a signal quality of each of the first and second signals, and a terminal controlled threshold generator configured to generate a terminal controlled threshold corresponding to a signal below which the terminal electronic device cannot decode the signals of the first and second network cells. A comparator module is configured to determine whether the signal qualities of both the first and second signals exceed the terminal controlled threshold, and when the signal qualities of both the first and second signals exceed the terminal controlled threshold, the comparator module activates dual standby paging. The comparator module further is configured to determine whether the signal qualities of both the first and second signals fall below the network controlled threshold, and when the signal qualities of both the first and second signals fall below the network controlled threshold, the comparator module outputs an initiation signal for initiation of a public land mobile network scan (PLMN) measurement.

In exemplary embodiments, the cellular terminal electronic device includes a non-transitory computer readable medium storing computer program code which when executed constitutes the signal quality determination section, the terminal controlled threshold generator, and the comparator module. The non-transitory computer readable medium may be the memory 45 or like memory device stored as part of the modem, or as another memory component within the terminal. The cellular terminal electronic device further includes a controller configured to execute the program code stored on the non-transitory computer readable medium. The controller may include the control circuit 41 and/or processing device 42, or like electronic control device incorporated as part of the modem, or as another electronic control device component within the terminal.

Another aspect of the invention is a method of performing enhanced idle mode signal reduction signaling with a cellular terminal electronic device to determine whether to perform a PLMN scan measurement. The method includes the steps of: receiving a first signal from a first network cell and a second signal from a second network cell, wherein the first network cell and the second network cell are on different networks; determining a signal quality of each of the first and second signals; receiving a network controlled threshold corresponding to a signal below which the terminal is expected by the network to start finding a more suitable cell within which to operate; generating a terminal controlled threshold corresponding to a signal below which the terminal cannot decode the signals of the first and second network cells; determining whether signal qualities of both the first and second signals exceed the terminal controlled threshold, and when the signal qualities of both the first and second signals exceed the terminal controlled threshold activating dual standby paging; determining whether the signal qualities of both the first and second signals fall below the network controlled threshold; and when the signal qualities of both the first and second signals fall below the network controlled threshold, performing a PLMN measurement.

Referring again to FIGS. 4 and 5, additional features of the cellular terminal electronic device/mobile telephone 10 will now be described. For the sake of brevity, generally conventional features of the mobile telephone 10 will not be described in great detail herein.

The mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from the memory 45. Display 14 may be used to display pictures, video, and the video portion of multimedia content. Additional displays (not shown) may be provided on the outside of mobile telephone 10 that are visible when the clamshell is in the closed position.

The mobile telephone 10 has a keypad 18 that provides for a variety of user input operations. Keypad 18 typically includes alphanumeric keys for allowing entry of alphanumeric information such as telephone numbers, phone lists, contact information, notes, etc. In addition, keypad 18 typically includes special function keys such as a “send” key for initiating or answering a call, and others. Some or all of the keys may be used in conjunction with the display as soft keys. Keys or key-like functionality also may be embodied as a touch screen associated with a display 14.

The mobile telephone 10 also may include a short range wireless interface 12. For example, the short range wireless interface 12 may be a Bluetooth, RFID, Near Field Communication (NFC) device, and/or like interface for wirelessly communicating with other devices over a short range interface. Such communication may be performed via the antenna 44 and the radio circuit 46 referenced above utilized generally for communications, or by a separate and dedicated antenna and radio circuitry specifically configured for short range communications.

The mobile telephone 10 further includes a sound signal processing circuit 48 for processing audio signals transmitted by and received from the radio circuit 46. Coupled to the sound processing circuit 48 are a speaker 70 and microphone 72 that enable a user to listen and speak via the mobile telephone 10 as is conventional.

The display 14 may be coupled to the control circuit 41 by a video processing circuit 74 that converts video data to a video signal used to drive the various displays. The video processing circuit 74 may include any appropriate buffers, decoders, video data processors and so forth. The video data may be generated by the control circuit 41, retrieved from a video file that is stored in the memory 45, derived from an incoming video data stream received by the radio circuit 46 or obtained by any other suitable method. The mobile telephone 10 also may include an I/O interface 76 that permits connection to a variety of I/O conventional I/O devices. One such device is a power charger that can be used to charge an internal power supply unit (PSU) 78.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. A cellular terminal electronic device comprising:
a modem including a radio circuit configured to receive a first signal from a first network cell and a second signal from a second network cell, wherein the first network cell and the second network cell are on different networks, and the radio circuit further is configured to receive a network controlled threshold corresponding to a signal below which the terminal does not operate within the network cells;
a signal quality determination section configured to determine a signal quality of each of the first and second signals;
a terminal controlled threshold generator configured to generate a terminal controlled threshold corresponding to a signal below which the terminal cannot decode the signals of the first and second network cells; and
a comparator module configured to determine whether the signal qualities of both the first and second signals exceed the terminal controlled threshold, and when the signal qualities of both the first and second signals exceed the terminal controlled threshold the comparator module activates dual standby paging; and is further configured to determine whether the signal qualities of both the first and second signals fall below the network controlled threshold, and when the signal qualities of both the first and second signals fall below the network controlled threshold, the comparator module outputs an initiation signal for initiation of a public land mobile network (PLMN) scan measurement.

2. The cellular terminal electronic device of claim 1, wherein the terminal controlled threshold generator generates a terminal controlled threshold that is less than the network controlled threshold.

3. The cellular terminal electronic device of claim 2, wherein the terminal controlled threshold generator terminal controlled threshold is at least 10 dB less than the network controlled threshold.

4. The cellular terminal electronic device of claim 1, further comprising a PLMN scanner configured to receive the initiation signal from the comparator module and in response to the initiation signal, perform a PLMN scan.

5. The cellular terminal electronic device of claim 1, wherein the radio circuit is configured to receive paging in the first network cell and the second network cell during dual standby paging.

6. The cellular terminal electronic device of claim 1 further comprising:
a non-transitory computer readable medium storing computer program code which when executed comprises the signal quality determination section, the terminal controlled threshold generator, and the comparator module; and
a controller configured to execute the program code stored on the non-transitory computer readable medium.

7. A communications system comprising:
the cellular terminal electronic device of claim 1;
a first network that includes the first network cell; and
a second network that includes the second network cell, wherein the first network is different from the second network.

8. The communications network of claim 7, wherein the first network cell is on a legacy network and the second network cell is on a higher prioritized network.

9. The communications network of claim 8, wherein the legacy network is a 3G network and the higher prioritized network is a 4G Long Term Evolution (LTE) network.

10. A method of performing enhanced idle mode signal reduction signaling with a cellular terminal electronic device comprising the steps of:
receiving a first signal from a first network cell and a second signal from a second network cell, wherein the first network cell and the second network cell are on different networks;
determining a signal quality of each of the first and second signals;
receiving a network controlled threshold corresponding to a signal below which the terminal is expected by the network to start finding a more suitable cell within which to operate;
generating a terminal controlled threshold corresponding to a signal below which the terminal cannot decode the signals of the first and second network cells;
determining whether signal qualities of both the first and second signals exceed the terminal controlled threshold, and when the signal qualities of both the first and second signals exceed the terminal controlled threshold, activating dual standby paging;
determining whether the signal qualities of both the first and second signals fall below the network controlled threshold; and
when the signal qualities of both the first and second signals fall below the network controlled threshold, performing a public land mobile network scan (PLMN) measurement.

11. The method of claim 10, wherein the first network cell is on a legacy network and the second network cell is on a higher prioritized network.

12. The method of claim 11, wherein the legacy network is a 3G network and the higher prioritized network is a 4G Long Term Evolution (LTE) network.

13. The method of claim 12, wherein the first network cell is within a routing area of the 3G network and the second network cell is within a tracking area of the 4G LTE network.

14. The method of claim 10, wherein the terminal controlled threshold is less than the network controlled threshold.

15. The method of claim 14, wherein the terminal controlled threshold is at least 10 dB less than the network controlled threshold.

16. The method of claim 15, wherein the terminal controlled threshold is at least 15 dB less than the network controlled threshold.

17. The method of claim 10, wherein the network controlled threshold is different for each of the first signal and the second signal.

18. The method of claim 10, wherein the terminal controlled threshold is different for each of the first signal and the second signal.

19. The method of claim 10, wherein when it is determined that only one of the first signal or second signal falls below the network controlled signal, maintaining the dual standby paging.

20. The method of claim 10, wherein when it is determined that one of the first signal or second signal falls below the terminal controlled signal, entering a single network standby mode.
